(19) United States
(12) Patent Application Publication
(10) Pub. No.: US 2016/0110122 A1
(43) Pub. Date: Apr. 21, 2016

(54) DATA ARCHIVING SYSTEM AND METHOD

(71) Applicant: Soteria Systems, LLC, Alpharetta, GA (US)

(72) Inventors: Junghee LEE, San Antonio, TX (US); Jongman KIM, Alpharetta, GA (US); Pranith KUMAR, Atlanta, GA (US); Monjur ALAM, Atlanta, GA (US)

(73) Assignee: SOTERIA SYSTEMS, LLC, Alpharetta, GA (US)

(21) Appl. No.: 14/515,947

(22) Filed: Oct. 16, 2014

(51) Int. Cl. G06F 3/06

(52) U.S. Cl. CPC G06F 3/0619; G06F 3/065; G06F 3/0683

(57) ABSTRACT

A data archiving device can be connected to a host device, and can include a version control system (VCS) unit configured to store archive data in a storage unit in response to the data archiving device detecting modifications to a host file of the host device. The archive data corresponds to the modifications and is processable to reconstruct previous versions of the host file. The VCS unit can be located in firmware that prevents overwriting and erasure operations in the storage unit by a user. The data archiving device can retrieve, upon receiving a request for a previous version of the host file, relevant archive data associated with the previous version of the host file. The data archiving device can forward the relevant archive data to the management device to enable the management device to reconstruct the previous version of the host file.

### BACKGROUND

1. Field

The following description relates to a system and method for archiving data.

2. Description of Related Art

The demand for secure data storage is increasing due to cyber crimes becoming more intelligent, organized and threatening. In particular, storage for forensic data needs to be secured in order to prevent malicious users from tampering with stored data. Software-based security solutions cannot assure the integrity of forensic data because the software-based solutions themselves can be compromised through tampering by malicious users. If software-based security solutions are compromised, one can no longer trust the data managed by the software software-based security solutions.

Tamper-proof security solutions for archiving data are often sought after.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect of the disclosure, a data archiving device includes a first device interface configured to connect the archiving device to a host device, and a processor device including a version control system (VCS) unit configured to store archive data in a first storage unit in response to the data archiving device detecting modifications to a host file of the host device. The archive data corresponds to the modifications and is processable to reconstruct at least one previous version of the host file.

The first storage unit can be located in the data archiving device.

The VCS unit can be located in firmware configured to prevent overwriting and erasure operations in the first storage unit by a user.

The archive data can include a currently stored archive file corresponding to a latest version of the host file among the at least one previous version of the host file, and hashes indicating the modifications.

The VCS unit can be configured to: designate, in response to an amount of the archive data in the first storage unit equaling or exceeding a threshold amount of data, selected hashes among the hashes to transfer; store a checksum of the selected hashes in the first storage unit; and transfer the selected hashes and a copy of the checksum to a second storage unit located in an external device.

The first storage unit can be located in the data archiving device, and the external device can include a management device configured to reconstruct the at least one previous version of the host file based on the archive data.

The data archiving can include a second device interface configured to connect the data archiving device to a management device in communication with the host device, and the management device can be configured to manage access to the archive data by a user of the host device.

The processor device can include: a retriever unit configured to retrieve, in response to the management device forwarding to the data archiving device a request from the host device for a previous version of the host file among the at least one previous version of the host file, relevant archive data associated with the previous version of the host file among the archive data; and a forwarder unit configured to forward the relevant archive data to the management device to enable the management device to reconstruct the previous version of the host file.

The processor device can be configured to send an alert to a management device in response to failing to detect modifications to the host file for a period of time that equals or exceeds a threshold period of time.

According to another general aspect, a method of archiving data includes: detecting, using a processor device of a data archiving device, modifications to a host file on a host device, the host device being connected to the archiving device; and storing, using a version control system (VCS) unit of the processor device, archive data in a first storage unit, the archive data corresponding to the modifications and being processable to reconstruct at least one previous version of the host file.

The version control system unit can be located in firmware configured to prevent overwriting and erasure operations in the first storage unit by a user.

Storing the archive data can include storing a currently stored archive file corresponding to a latest version of the host file among the at least one previous version of the host file, and hashes indicating the modifications.

The method can include, in response to an amount of the archive data in the first storage unit equaling or exceeding a threshold amount of data: designating, using the VCS unit, selected hashes among the hashes to transfer; storing, using the VCS unit, a checksum of the selected hashes in the first storage unit; and transferring the selected hashes and a copy of the checksum to a second storage unit located in an external device.

The first storage unit can be located in the data archiving device, and the external device can include a management device configured to reconstruct the at least one previous version of the host file based on the archive data.

The method can include, in response to a management device forwarding to the data archiving device a request from the host device for a previous version of the host file among the at least one previous version of the host file: retrieving, using a retriever unit of the processor device, relevant archive data associated with the previous version of the host file among the archive data; and forwarding, using a forwarder unit of the processor device, the relevant archive data to the management device to enable the management device to reconstruct the previous version of the host file.

According to another general aspect, a management device for managing access to data, can include at least one processor operable to: receive a request from a host device for a previous version of a host file of the host device; forward the request to a data archiving device connected to the host device, the data archiving device including archive data associated with the previous version of the host file; receive the archive data from the data archiving device; and reconstruct the previous version of the host file by using a version control (VCS) unit to process the archive data.

The archive data can include a currently stored archive file corresponding to a latest version of the host file, and at least one hash indicating modifications to the host file.

The management device can be configured to: receive, in response to an amount of the archive data in a first storage unit of the data archiving device equaling or exceeding a threshold amount of data, selected hashes among the at least one hash, and a copy of a checksum of the selected hashes; and store the selected hashes and the copy of the checksum in a second storage unit located in the management device.

The management device can be configured to receive an alert from the data archiving device in response to the data archiving device failing to detect modifications to the host file for a period of time that equals or exceeds a threshold period of time.

Other features and aspects will be apparent from the following detailed description, the drawings, and the claims.

### BRIEF DESCRIPTION OF THE DRAWINGS

FIG. 1 is a schematic diagram of an example data archiving system.

FIG. 2 is a top-level schematic diagram of an example data archiving system.

FIGS. 3 and 4 illustrate an example method of storing data in the data archiving system of FIG. 2.

FIGS. 5 and 6 illustrate an example method of storing data in the data archiving system of FIG. 2.

FIGS. 7 and 8 illustrate an example method of retrieving a previous version of a file from the data archiving system of FIG. 2.

Throughout the drawings and detailed description, unless otherwise described, the same drawing reference numbers/characters will be understood to refer to the same elements, features and functions. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, examples will be described in detail with reference to the accompanying drawings, wherein like reference numerals refer to like elements throughout.

Various alterations and modifications may be made to the examples, some of which will be illustrated in detail in the drawings and detailed description. However, it should be understood that these examples are not construed as limited to the illustrated forms and include all changes, equivalents or alternatives within the idea and the technical scope of this disclosure.

The terminology used herein is for the purpose of describing particular examples only and is not intended to be limiting. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

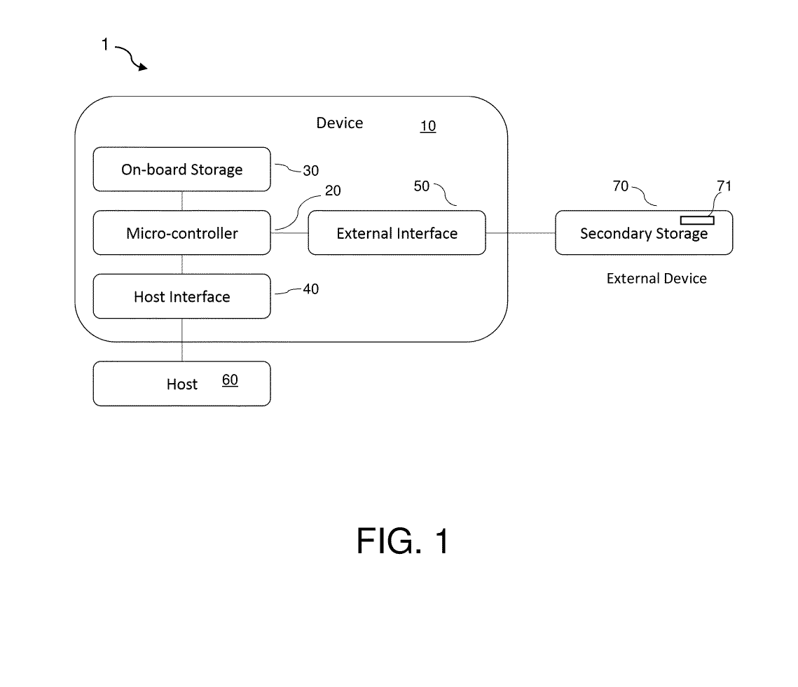

FIG. 1 is a schematic diagram of a data archiving system 1 including an archiving device 10, according to an example. The archiving device 10 can be a dedicated hardware device, for example, including a microcontroller 20, on-board storage unit 30 connected to the microcontroller 20, a host device interface 40 and an external device interface 50. The microcontroller 20 is connected to the on-board storage unit 30 to control storage of data and access to data therein. The microcontroller 20 is connected to the host device interface 40 and external device interface 50 to control communication with a host device 60 and an external device or computer 70, respectively.

The microcontroller 20 can include one or more microprocessor devices, firmware operated by the one or more processors and one or more controllers configured to control the host interface 40 and external device interface 50. The firmware may be, for example, ROM, EPROM or flash memory.

The on-board storage unit 30 can be an SD card, microSD card or any type of non-volatile memory such as NAND flash memory or PRAM, for example. The host device interface 40 can be a PCI interface, PCIe interface, SCSI interface or SATA interface, for example for connecting the archiving device 10 to the host device 60. The external device interface 50 can be a UART interface, USB interface or Ethernet interface, for example, for connecting the archiving device to the host management device 70.

The host device 60 can be, for example, a desktop computer, laptop computer, tablet computer, or a smartphone. The host device can include one or more processors, one or more memory devices, firmware or software, or any combination thereof.

The external device 70 can be, for example a computer device or server device including one or more processors, one or more memory devices, firmware or software, or any combination thereof.

As will be described in greater detail, the archiving device 10 is configured to monitor registered software/data files of the host device 60 and record events (e.g, changes or modifications) that occur in the registered files. More specifically, the archiving device 10 is configured to securely store archive data associated with the registered files in the on-board storage unit 30 of the archiving device 10 and/or a secondary storage unit 71 of the external device 70, and thereby record modification histories of the registered files. For example, the archive data can include archive files corresponding to latest versions of monitored files and hashes including changes to the registered files. Accordingly, previous versions of a registered file can be reconstructed based on one or more respective hashes and a respective archive file. Registered files can include any type of software file or data file that is registered for monitoring by the archiving device 10.

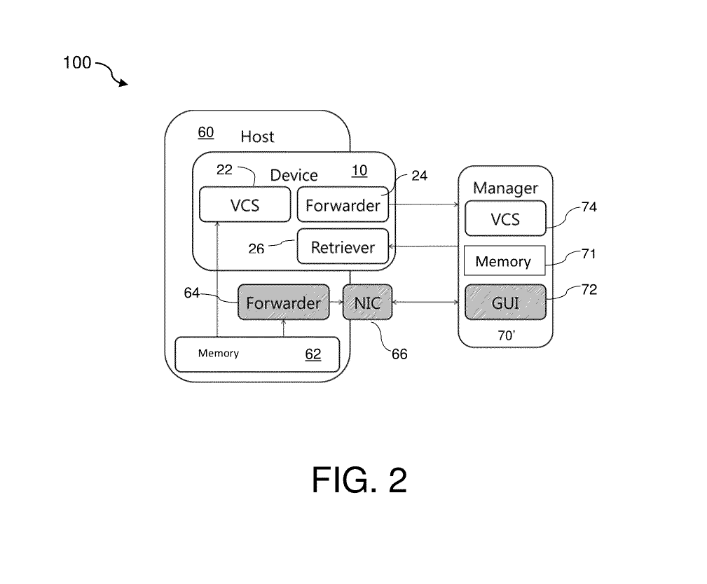

FIG. 2 is a top-level schematic diagram of an archiving system 100. The archiving system 100 includes the archiving device 10, the host device 60 and a management device 70′. The management device 70′ is connected to the external device interface 50 (FIG. 1) of the archiving device 10. The management device 70′ can be, for example, an external device such a computer device or server device including one or more processors, one or more memory devices, firmware or software, or any combination thereof, configured to manage access of the host device 60 to the archive data of the host device 60. Additionally, as is explained in greater detail below, the management device 70′ can provide secondary/alternate alternate storage for the archive data of the host device 60, and/or for receiving archive data transferred from the host device 60 once the amount of archive data in the on-board storage unit 30 exceeds a pre-determined threshold amount.

Although a single archiving device 10 and host device 60 are shown in FIG. 2, multiple archive devices 10 and host devices 60 can be included in the system 1. For example, an archiving device 10 can be connected to each host device 60 and the host management device 70 can be a centralized management device connected to each archive device 10 and host device 60. Thus, the host management device 70 can manage access of each host device 60 its archive data, and can provide secondary storage for the archive data of each host device 60.

Still referencing FIG. 2, the archiving device 10 includes a version control system (VCS unit) unit 22, a forwarder unit 24 and a retriever unit 26 running on the microcontroller 20 (FIG. 1). Although the VCS unit 22, forwarder unit 24 and retriever unit 26 are shown as separate components, according to an alternate example, the forwarder unit 24 and retriever unit 26 can be included in the VCS unit 22. According to preferred examples, the archiving device 10 is a dedicated device that does not support firmware modification, and the VCS unit 22, forwarder unit 24 and retriever unit 26 are provided in firmware of the microcontroller 20. The forwarder unit 24 of the archiving device 10 is configured to communicate with the management device 70′ via the external device interface 50 (FIG. 1). The management device 70′ is configured to communicate with the retriever unit 26 of the archiving device 10 via the external device interface 50. As described in greater detail below, the VCS unit 22 is configured to monitor registered software/data files of the host device 60 and maintain modification histories of the registered files by recording changes or modifications that occur in the registered files. The retriever unit 26 is configured to retrieve archive data from the on-board storage unit 30 of the archiving device 10 in response to a request for the archive data by the user of the host device 60. The forwarder unit 26 is configured to forward archive data to the management device 70′ in order to enable the management device 70′ to store the archive data and/or enable the management device 70′ to provide the archive data to the host device 60 in response to a request by a user of the host device 60.

As shown in FIG. 2, the host device includes host memory 62 configured to communicate with the VCS unit 22 of the archiving device 10 via the host device interface 50 (FIG. 1), a forwarder unit 64 and a network interface controller (NIC) 66 in communication with the forwarder unit 64 and connecting the host device 60 to the management device 70′. The host memory 62 can include an optical disc such as a DVD-ROM or CD-ROM, a hard disc drive, an SD card, a microSD card, any type of non-volatile memory such as NAND flash memory or PRAM, or any combination thereof. The forwarder unit 64 can include one or more processors, firmware and/or software configured to collect and transfer information about events that occur in the host device 60 to the management device 70′.

Continuing with reference to FIG. 2, the management device 70′ includes a secondary/alternate storage unit 71, a graphic user interface (GUI) 72 which can be displayed on a display (not shown) the management device 70′, and a VCS unit 74 that is configured to process archive data to reconstruct previous versions of monitored files of the host device 60. The forwarder unit 64 of the host device 60 and the management device 70′ are configured to communicate with each other via the NIC 66. The forwarder unit 64 of the host device 60, the NIC 66 and the GUI 72 can be components of an open-source intrusion detective system, such as the OSSEC system (www.ossec.net) developed by the OSSEC Project and sponsored by Trend Micro of Irving Tex. The VCS unit 74 can include, for example, one or more processors, one or more memory devices, software, firmware, or any combination thereof.

The GUI 72 is configured to receive user input including a request from a user of the host device 60, and forward the request to the retriever unit 26 of the archiving device 10 so that the retriever unit 26 can retrieve archive data related to the request that is stored in the archiving device 10 and/or the management device 70′. Additionally, the GUI 72 is configured to display information to a user of the host device 60 regarding an event (e.g., change to a monitored file of the host device) that occurs in the host device 60. The management device 70′ can analyze the event and, if the event is determined to be a possible intrusion, send an alert to the administrator of the host device 60.

As illustrated in FIG. 2, in addition to the system 100 providing a connection between the host device 60 and the management device 70′ through the NIC 66, the archiving device 10 provides the host device 60 with a connection to the management device 70′ through the host device interface 40 and the external device interface 50. The connection between the host device 60 and the management device 70′ provided by the archiving device 10 forms a physically separated network that is not visible to the host device 60 and remote users. Further still, in preferred examples in which the archiving device 10 does not support firmware modification, the firmware including the VCS unit 22, forwarder unit 24 and retriever unit 26 cannot be compromised. Because the connection between the host device 60 and the management device 70′ provided by the archiving device 10 is not visible to the host device and remote users, and because the firmware of the archiving device 10 cannot be compromised, any data stored in the on-board storage unit 30 of the archive device 10 cannot be compromised. Even an administrator cannot erase or modify data once the data is stored in the on-board storage unit 30 of the archiving device 10. Thus, the network formed by the archiving device 10 provides a safer medium for administration than a traditional network connected through the NIC 66 would provide.

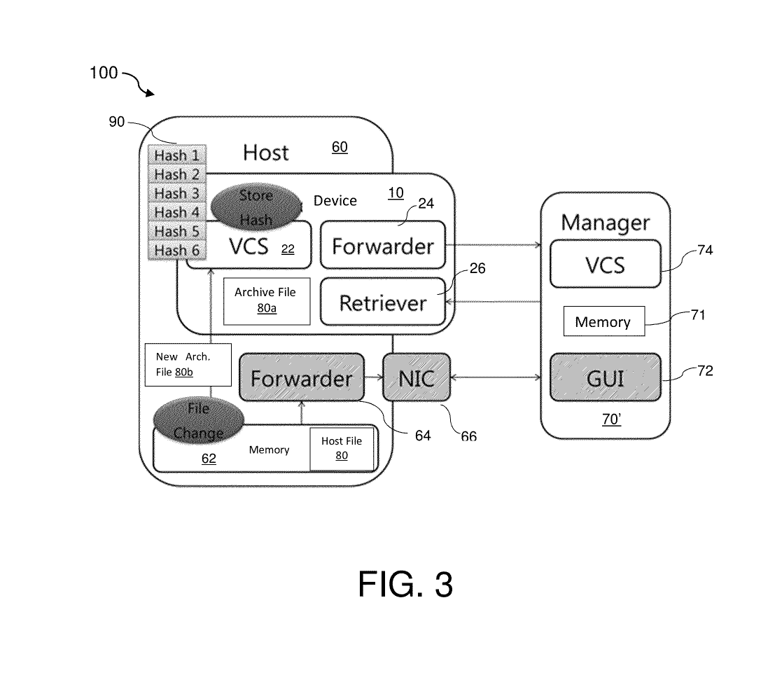

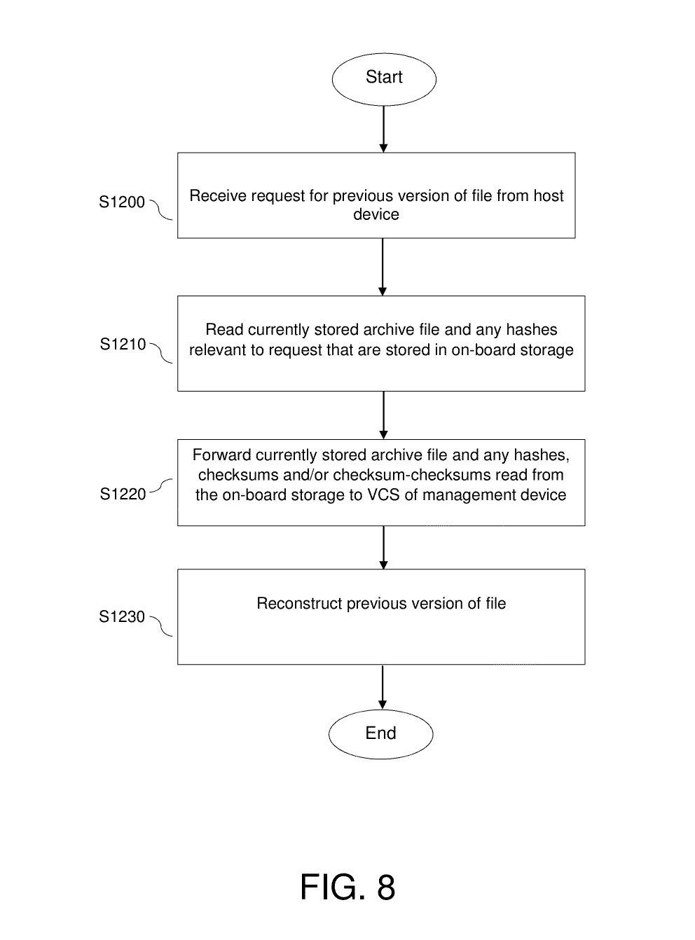

Operation of the system 100 according to exemplary processes are described below with reference to FIGS. 3-8.

Data Archiving

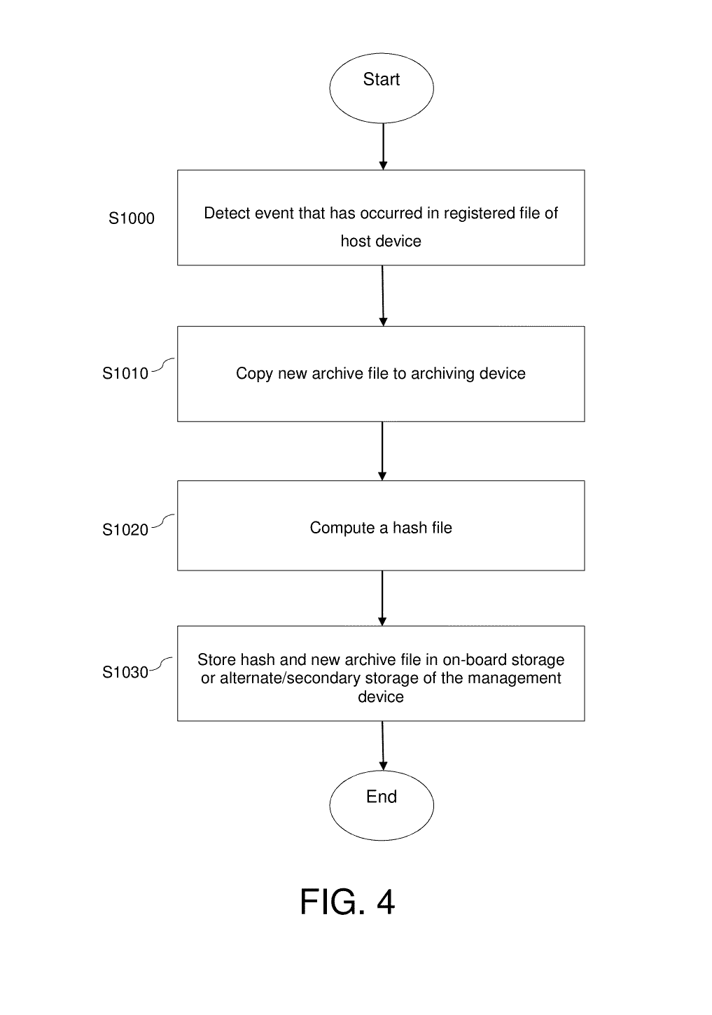

FIGS. 3 and 4 are a schematic diagram and flow chart, respectively, illustrating a method of recording events (e.g., file changes) that occur in registered files of the host device 60. More specifically, FIGS. 3 and 4 illustrate a method of archiving data associated with registered files of the host device 60.

Referring to FIGS. 3 and 4, in step S1000, the archiving device 10 detects that an event has occurred in a registered file 80 of the host device 60. In step S1010, when an event occurs in a registered file 80 of the host device 60, a new archive file 80b, which is a new version of the registered file 80 including one or more differences associated with the event, is copied to the archiving device 10. Thereafter, in step S1020, the VCS unit 22 of the archive device 10 computes a hash file (or “hash”) 90 by comparing the new archive file 80b to a currently stored archive file 80a, which is a latest version of the file 80 stored in the on-board storage unit 30 of the archive device 10. The hash 90 indicates the difference(s) between the new archive file 80b and the currently stored archive file 80a. Then, in step S1030, the VCS 22 stores the hash 90 and the new archive file 80b in the on-board storage unit 30 or the alternate/secondary storage unit of the management device 70′, and deletes the currently stored archive file 80a from the on-board storage unit 30 or the alternate/secondary storage unit 71 of the management device 70′. Thus, the new archive file 80b overwrites the currently stored archive 80a. Upon overwriting of the currently stored archive file 80a, the new archive file 80b becomes a currently stored archive file 80a. The hash 90 is permanently retained, never to be replaced or erased. The latest version of the file 80 is retained in the on-board storage unit 30 or the alternate/secondary storage unit 71 until another event occurs in the registered file 80. Each time a new event occurs, the VCS 22 computes a hash 90, stores the hash 90 in the on-board storage unit 30 or the alternate/secondary storage unit 71 of the management device 70′ along with any previous hashes 90, and replaces the currently stored archive file 80a with a new archive file 80b.

When the hashes 90 and the currently stored archive file 80a are stored in alternate/secondary storage unit 71 of the management device 70′, as opposed to the on-board storage unit 30, data stored in the management device 70 can be tampered with. Therefore, in preferred examples, the firmware including the VCS unit 22, forwarder unit 24 and retriever unit 26 cannot be compromised, and the hashes 90 and the currently stored archive file 80a are stored in the on-board storage unit 30. Thus, the hashes 90 and the currently stored archive file 80a in the on-board storage unit 30 cannot be altered outside of the protocol provided by the firmware. Accordingly, the hashes 90 and the currently stored archive file 80a cannot be compromised by a user of the host device 60 or a remote user. Even an administrator cannot erase or modify data once the data is stored in the archiving device 10.

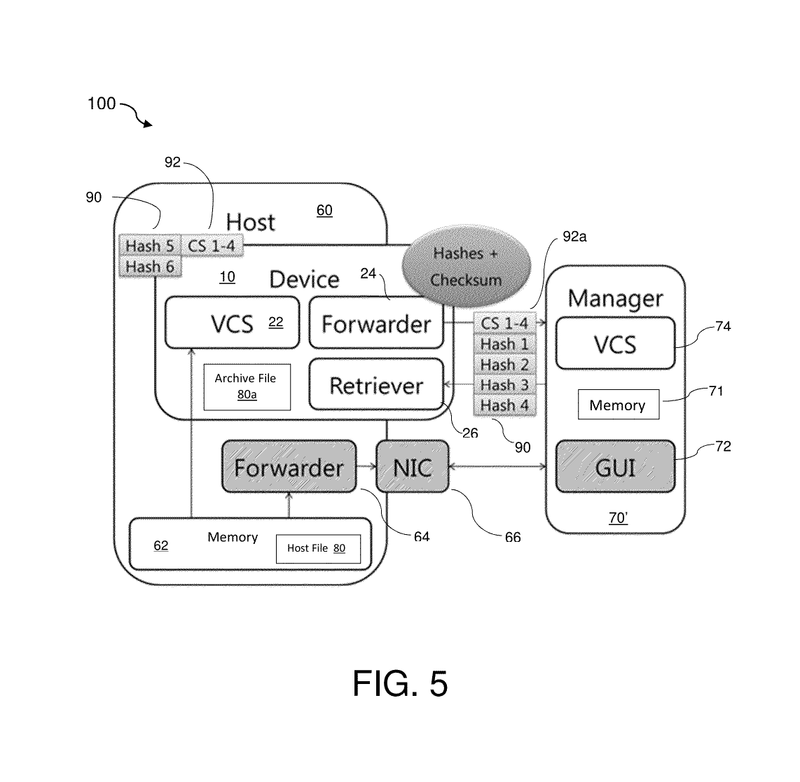

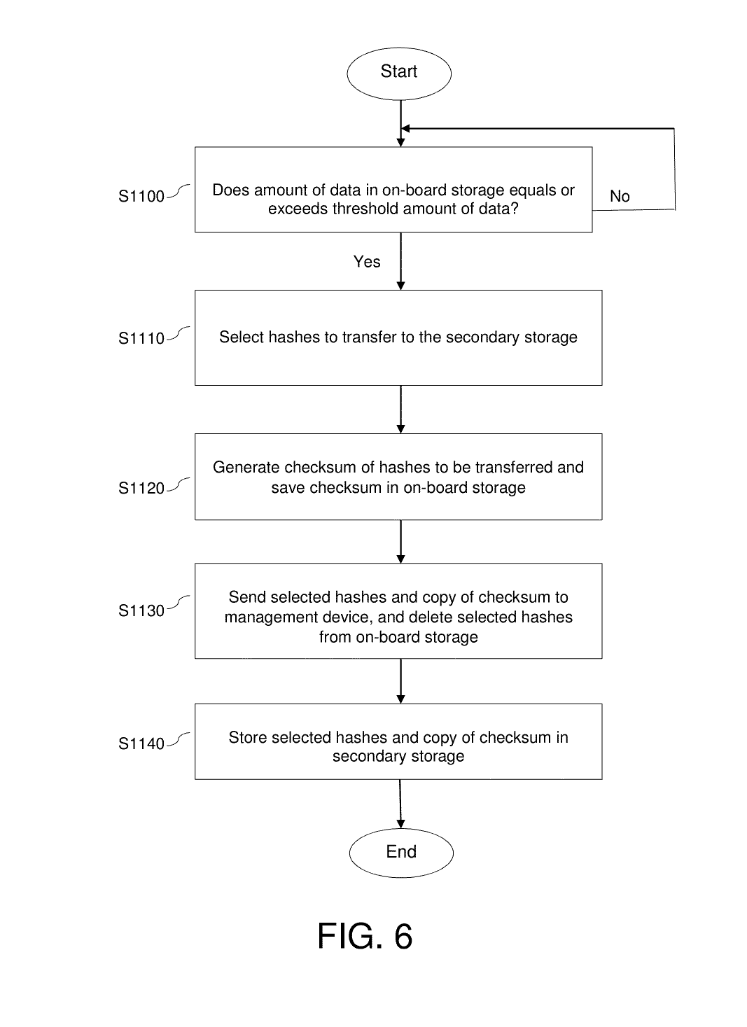

When the hashes 90 and the currently stored archive file 80a are stored in the on-board storage unit 30, the on-board storage unit will eventually become full as hashes 90 are repeatedly appended in memory. Accordingly, an exemplary method for addressing the storage limitations of the on-board storage unit 30 is illustrated in FIGS. 5 and 6.

FIGS. 5 and 6 illustrate a method for transferring data from the on-board storage unit 30 of the archiving device 10 to the secondary storage unit 71 of the management device '70. In the example shown in FIGS. 5 and 6, the archiving device 10 can be further configured to transfer data from the on-board storage unit 30 to the secondary storage unit 71 of the management device 70′ upon the on-board storage unit 30 becoming filled with data to or over a threshold data amount, thereby freeing storage space in the on-board storage unit 30 to store additional data. Although the data is transferred from the on-board storage unit 30 to the secondary storage unit 71 of the management device 70′ in the disclosed example, it should be understood that the on-board storage unit 30 can alternatively transfer data to a secondary storage unit of another external device.

As shown in FIGS. 5 and 6, in step S1100, the archive device 10 determines whether the amount of data (the hashes 90 plus the currently stored archive file 80a) in the on-board storage unit 30 equals or exceeds a pre-defined threshold amount of data. In step S1110, if the amount of data in the on-board storage unit 30 meets or exceeds the pre-determined threshold amount of data, the archive device 10 (e.g., VCS unit 22) selects hashes 90 to transfer to the secondary storage unit 71 of the management device 70′. Then, in step S1120, the VCS unit 22 generates a checksum 92 of the hashes 90 to be transferred, and saves the checksum 92 in the on-board storage unit 30. In step S1130, the forwarder unit 24 of the archive device 10 sends the selected hashes 90 and a copy 92a (“checksum copy”) of the checksum 92 to the management device 70′, and the VCS unit 22 deletes the selected hashes 90 from the on-board storage unit 30. In step S1140, the management device 70′ stores the selected hashes 90 and the checksum copy 92a in its secondary storage unit. Thus, upon transfer of the selected hashes 90 to the management device 70′, previously occupied storage space is made available in the on-board storage unit 30 for the storage of additional data (e.g., hashes 90 and checksums 92).

In the exemplary method of FIGS. 5 and 6, the on-board storage unit 30 will eventually become filled to or over the threshold data amount with checksums 92. Accordingly, the process explained with respect to FIGS. 5 and 6 can be applied recursively to checksums 92. More specifically, when on-board storage unit 30 will eventually become filled to or over the threshold data amount with checksums 92, selected checksums 92 can be sent/saved to the management device 70′ and deleted from the on-board storage unit 30. When selected checksums 92 are transferred in this manner, the VCS unit 22 generates a checksum of the selected checksums 92 (“checksum-checksum”, not shown) and saves the checksum-checksum in the on-board storage unit 30. The forwarder unit 24 sends the checksums 92 and a copy of the checksum-checksum (“checksum-checksum copy”) to the management device 70′. The selected checksums 92 and the checksum-checksum copy are then stored in the secondary storage unit 71 of the management device 70′.

Since hashes 90 and checksum copies 92a that are stored in the management device 70′ may not be tamper-proof, and therefore can be compromised, the integrity of hashes 90 and checksum copies 92a that are stored in the management device 70′ can be checked based on the corresponding checksums 92 and checksum-checksums stored in the on-board storage unit 30 of the archiving device 10.

File Reconstruction

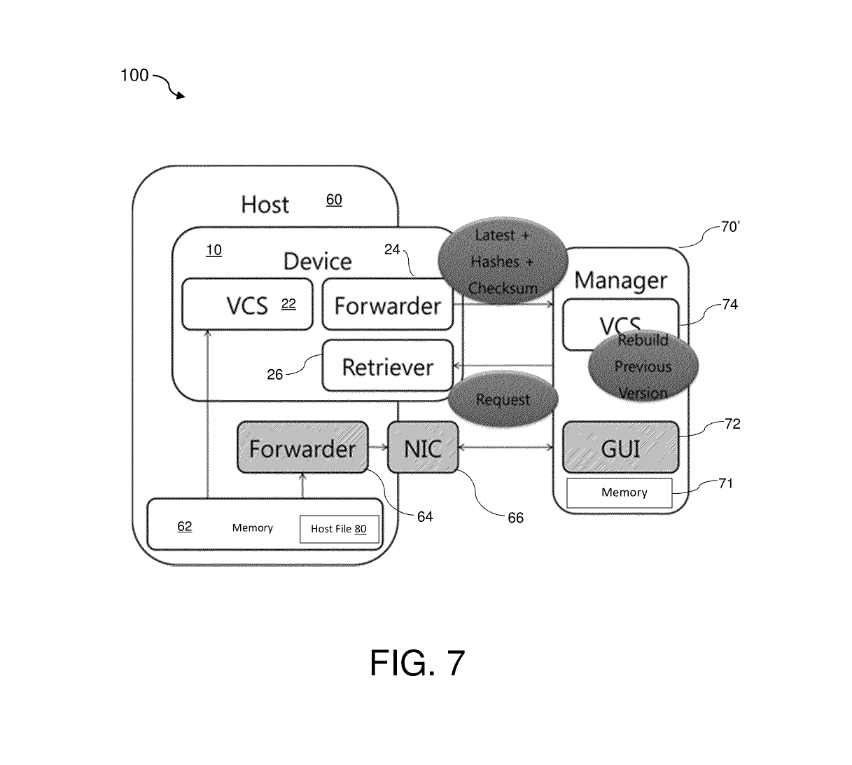

FIGS. 6 and 7 illustrate an exemplary method of retrieving a previous version of a registered file 80 using the archiving device 10 and the management device 70′. As shown in FIGS. 6 and 7, in step 1200, a user can input the request for the previous version of a file to the host device 60 via the GUI 72. The request is passed to the management device 70′ through the GUI 72 and the NIC 66, and then from the management device 70′ to the retriever unit 26 of the archiving device 10. In step 1210, the retriever unit 26 reads the currently stored archive file 80a and any hashes 90 relevant to the request that are stored in the on-board storage unit 30. Still in step 1210, if any hashes 90 relevant to the request are stored in the management device 70′ (e.g., the hashes 90 have been transferred to/stored in the management device 70′ due to the management device 70′ having become filled up to or beyond the threshold amount of data), the retriever unit 26 reads from the on-board storage unit 30 the checksums 92 corresponding to the hashes 90 stored in the management device 70′. Further still in step 1210, if any relevant checksum-checksums are stored in the on-board storage unit 30 (e.g., the corresponding checksums 92 have been transferred to/stored in the management device 70′ due to the management device 70′ having become filled up to or beyond the threshold amount of data), the retriever unit 26 reads the corresponding checksum-checksums stored in the on-board storage unit 30. Thereafter, in step 1220, the forwarder unit 24 of the archiving device 10 forwards the currently stored archive file 80a and any hashes 90, checksums 92a and/or checksum-checksums read from the on-board storage unit 30 to the VCS unit 74 of the management device 70′. Then, in step S1230, the VCS unit 74 reconstructs the requested previous version of the file 80 based on the currently stored archive file 80a in combination with: relevant hashes 90 received from the forwarder unit 24; relevant hashes 90 stored in the secondary storage unit 71 and corresponding checksums 92 received from the forwarder unit 24; and/or relevant hashes 90 stored in the secondary storage unit, corresponding checksums 92 stored in the secondary storage unit 71 and corresponding checksum-checksums received from the forwarder unit 24. The user can access the requested previous version of the file 80 on the manager 70′ through the GUI 72.

Security Alerts

In the examples provided above, a device driver is needed on the host device 60 in order for the host device 60 and the archiving device 10 to interact with each other. Although the firmware of the archiving device 10 cannot be compromised in preferred examples, the device driver on the host device might become compromised. It would be difficult for a malicious user to replace the device driver of the host device 60 with a new device driver that is still compatible with the archiving device 10 but operates in a way that is not expected/desired by the system 100. However, it would be relatively easier to disable the device driver on the host device 60 in various ways. Once the device driver is disabled, the archiving device 10 can no longer record events related to registered files on the host device 60. Accordingly, the archiving device 10 can be configured to send an alert to the management device 70′ via the forwarder unit 24, and/or send an alert to the host device 60 via the host device interface 50, if the archiving device 10 does not detect any events on the host device 60 for a period of time that equals or exceeds a threshold period of time.

In the examples of FIGS. 2-8, a separate management device 70′ is employed. However, the management device 70′ can be omitted, and the user of the host device 60 can access the data stored in the on-board storage unit 30 of the archiving device 10 directly from the host device 60. In such a case, old data can be gradually removed from the on-board storage unit 30.

The VCS unit 22 of the archiving device 10 according to the disclosed examples can be simple. As long as the VCS unit 22 does not allow overwriting and erase operations by a user or administrator (other than the programmed overwriting of currently stored archive files 80a by new archive files 80b associated with events on the host device 60), any type of VCS unit 22 can be used. For example, if a type of VCS unit 22 allows only append and read operations, the VCS unit 22 can be used even if it does not explicitly support various utilities as a relatively sophisticated VCS unit does.

The units described herein may be implemented using hardware components and software components. For example, the hardware components may include controllers, sensors, generators, drivers, processing devices, and other equivalent electronic components. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A data archiving device, comprising:
a first device interface configured to connect the archiving device to a host device;
a processor device comprising a version control system (VCS) unit configured to store archive data in a first storage unit in response to the data archiving device detecting modifications to a host file of the host device, the archive data corresponding to the modifications and being processable to reconstruct at least one previous version of the host file.

2. The data archiving device of claim 1, wherein the first storage unit is located in the data archiving device.

3. The data archiving device of claim 1, wherein the VCS unit is located in firmware configured to prevent overwriting and erasure operations in the first storage unit by a user.

4. The data archiving device of claim 1, wherein the archive data comprises:
a currently stored archive file corresponding to a latest version of the host file among the at least one previous version of the host file; and
hashes indicating the modifications.

5. The data archiving device of claim 4, wherein the VCS unit is configured to:
designate, in response to an amount of the archive data in the first storage unit equaling or exceeding a threshold amount of data, selected hashes among the hashes to transfer;
store a checksum of the selected hashes in the first storage unit; and
transfer the selected hashes and a copy of the checksum to a second storage unit located in an external device.

6. The data archiving device of claim 5, wherein the first storage unit is located in the data archiving device, and the external device comprises a management device configured to reconstruct the at least one previous version of the host file based on the archive data.

7. The data archiving device of claim 1, comprising a second device interface configured to connect the data archiving device to a management device in communication with the host device, wherein the management device is configured to manage access to the archive data by a user of the host device.

8. The data archiving device of claim 7, wherein the processor device comprises:
a retriever unit configured to retrieve, in response to the management device forwarding to the data archiving device a request from the host device for a previous version of the host file among the at least one previous version of the host file, relevant archive data associated with the previous version of the host file among the archive data; and
a forwarder unit configured to forward the relevant archive data to the management device to enable the management device to reconstruct the previous version of the host file.

9. The data archiving device of claim 1, wherein the processor device is configured to send an alert to a management device in response to failing to detect modifications to the host file for a period of time that equals or exceeds a threshold period of time.

10. A method of archiving data, comprising:
detecting, using a processor device of a data archiving device, modifications to a host file on a host device, the host device being connected to the archiving device;
storing, using a version control system (VCS) unit of the processor device, archive data in a first storage unit, the archive data corresponding to the modifications and being processable to reconstruct at least one previous version of the host file.

11. The method of claim 10, wherein the version control system unit is located in firmware configured to prevent overwriting and erasure operations in the first storage unit by a user.

12. The method of claim 10, wherein storing the archive data comprises storing:
a currently stored archive file corresponding to a latest version of the host file among the at least one previous version of the host file; and
hashes indicating the modifications.

13. The method of claim 12, comprising, in response to an amount of the archive data in the first storage unit equaling or exceeding a threshold amount of data:
designating, using the VCS unit, selected hashes among the hashes to transfer;
storing, using the VCS unit, a checksum of the selected hashes in the first storage unit; and
transferring the selected hashes and a copy of the checksum to a second storage unit located in an external device.

14. The method of claim 13, wherein the first storage unit is located in the data archiving device, and the external device comprises a management device configured to reconstruct the at least one previous version of the host file based on the archive data.

15. The method of claim 10, comprising, in response to a management device forwarding to the data archiving device a request from the host device for a previous version of the host file among the at least one previous version of the host file:
retrieving, using a retriever unit of the processor device, relevant archive data associated with the previous version of the host file among the archive data; and
forwarding, using a forwarder unit of the processor device, the relevant archive data to the management device to enable the management device to reconstruct the previous version of the host file.

16. A management device for managing access to data, comprising:
at least one processor operable to
receive a request from a host device for a previous version of a host file of the host device,
forward the request to a data archiving device connected to the host device, the data archiving device comprising archive data associated with the previous version of the host file,
receive the archive data from the data archiving device, and
reconstruct the previous version of the host file by using a version control (VCS) unit to process the archive data.

17. The management device of claim 16, wherein archive data comprises:
a currently stored archive file corresponding to a latest version of the host file; and
at least one hash indicating modifications to the host file.

18. The management device of claim 16, wherein the management device is configured to:
receive, in response to an amount of the archive data in a first storage unit of the data archiving device equaling or exceeding a threshold amount of data, selected hashes among the at least one hash, and a copy of a checksum of the selected hashes; and
store the selected hashes and the copy of the checksum in a second storage unit located in the management device.

19. The management device of claim 16, wherein the management device is configured to receive an alert from the data archiving device in response to the data archiving device failing to detect modifications to the host file for a period of time that equals or exceeds a threshold period of time.
